(19) United States
(12) Patent Application Publication
(10) Pub. No.: US 2017/0113431 A1
(43) Pub. Date: Apr. 27, 2017

(54) ULTRA-HIGH SPEED TRANSFER ROBOT FOR ULTRA-HIGH SPEED HYBRID PRESS

(71) Applicant: LOFA Corporation, Ulsan (KR)

(72) Inventor: Byung-guk Lee, Ulsan (KR)

(73) Assignee: LOFA Corporation

(21) Appl. No.: 15/333,459

(22) Filed: Oct. 25, 2016

(30) Foreign Application Priority Data
Oct. 26, 2015 (KR) 10-2015-0149040

(51) Int. Cl. B30B 15/30; B21D 43/04

(52) U.S. Cl. CPC B30B 15/30; B21D 43/04

(57) ABSTRACT

Disclosed is a transfer robot used for transferring a workpiece between presses in a press line, which can prevent a load from being intensively applied to only one spot while an arm of the transfer robot operates, thereby lowering maintenance.

The transfer robot includes a main plate which is formed horizontally and flat and of which a lengthwise direction is perpendicular to a transferring direction of the workpiece; a pair of arm units which are respectively hinge-coupled to both lengthwise ends of the main plate and include a plurality of arms rotating against each other on a plane parallel with the main plate; a workpiece coupling support which include opposite ends respectively coupling with the ends of the pair of arm units; and an elevating unit which moves the main plate up and down, each arm unit including a first arm coupling with the main plate 100 and rotating by a first motor and a second arm coupling with an end of the first arm and rotating as the first arm rotates, and the main plate sliding in the transferring direction of the workpiece with respect to the elevating unit.

### REFERENCE TO RELATED APPLICATIONS

This application is based upon and claims the priority benefit of Korean Patent Application No. 10-2015-0149040 filed on Oct. 26, 2015, the entire contents of which are incorporated herein by reference.

### FIELD OF THE INVENTION

Apparatuses and methods consistent with exemplary embodiments relate to a transfer robot used for transferring a workpiece between high-speed servo-presses in a press line for plate work, and more particularly to an ultra-high speed transfer robot for an ultra-high speed hybrid press, which can prevent a load from being intensively applied to only one spot while an arm of the transfer robot operates, thereby lowering maintenance.

### BACKGROUND OF THE INVENTION

In a press line for forming a chassis or the like of a vehicle, there is a means for transferring a workpiece between presses arranged in sequence to form the chassis.

Such a transfer means is roughly classified into a type using a loader/unloader and a type using a robot.

The transfer means using the loader/unloader includes a loader installed at an upstream press, an unloader installed at a downstream press, a carriage between the loader and the unloader, etc. and thus needs a space for installing the carriage or the like, thereby having a problem of requiring a large-scale press line.

On the other hand, the transfer means using the robot like a ‘conveying device’ disclosed in Japanese Patent No. 4402013 is capable of preventing the large-scale press line since there are no needs of the carriage for the loader/unloader type, but has a disadvantage to maintenance since a load is intensively applied to one spot while an arm of the robot repetitively operates within one section.

### SUMMARY OF THE INVENTION

One or more exemplary embodiments may provide an ultra-high speed transfer robot for an ultra-high speed hybrid press, which not only prevents a large-scale press line but also prevents a load from being intensively applied to only one spot while an arm of the transfer robot operates, thereby having an advantage of low-maintenance.

In accordance with an exemplary embodiment, there is provided an ultra-high speed transfer robot for transferring a workpiece from a first press to a second press in an ultra-high speed hybrid press line, the transfer robot including: a main plate which is formed horizontally and flat and of which a lengthwise direction is perpendicular to a transferring direction of the workpiece; a pair of arm units which are respectively hinge-coupled to both lengthwise ends of the main plate and include a plurality of arms rotating against each other on a plane parallel with the main plate; a workpiece coupling support which include opposite ends respectively coupling with the ends of the pair of arm units; and an elevating unit which moves the main plate up and down, each arm unit including a first arm coupling with the main plate and rotating by a first motor and a second arm coupling with an end of the first arm and rotating as the first arm rotates, the main plate sliding in the transferring direction of the workpiece with respect to the elevating unit, and the transfer robot further including a position control unit to make the end of the arm unit be stopped at a certain position by adjusting an angle of the arm unit in accordance with a sliding position of the main plate.

In accordance with another exemplary embodiment, the ultra-high speed transfer robot for the ultra-high speed hybrid press further includes a first tilting unit configured to tilt the main plate toward the transferring direction of the workpiece with respect to the elevating unit.

In accordance with still another exemplary embodiment, the workpiece coupling support includes: a connecting portion coupling with the pair of arm units; and a workpiece coupler connecting in parallel with the connecting portion and tiltable by a second tilting unit toward the transferring direction of the workpiece with respect to the connecting portion.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a front view of a transfer robot according to an exemplary embodiment;

FIG. 2 is a plan view of the transfer robot;

FIG. 3 illustrates that the transfer robot is installed in a press line;

FIG. 4 is a view for explaining an operation of the transfer robot;

FIGS. 5A and 5B are views for explaining a position control unit of the transfer robot; and

FIGS. 6A and 6B are views for explaining first and second tilting units of the transfer robot.

### DETAILED DESCRIPTION OF THE INVENTION

Below, exemplary embodiments will be described with reference to accompanying drawings.

These exemplary embodiments relate to a robot used for transferring a workpiece from one press to the other press in an ultra-high speed hybrid press line for plate work, which can prevent an intensive load from being repetitively applied to only one spot while the robot operates, thereby having an advantage of low-maintenance.

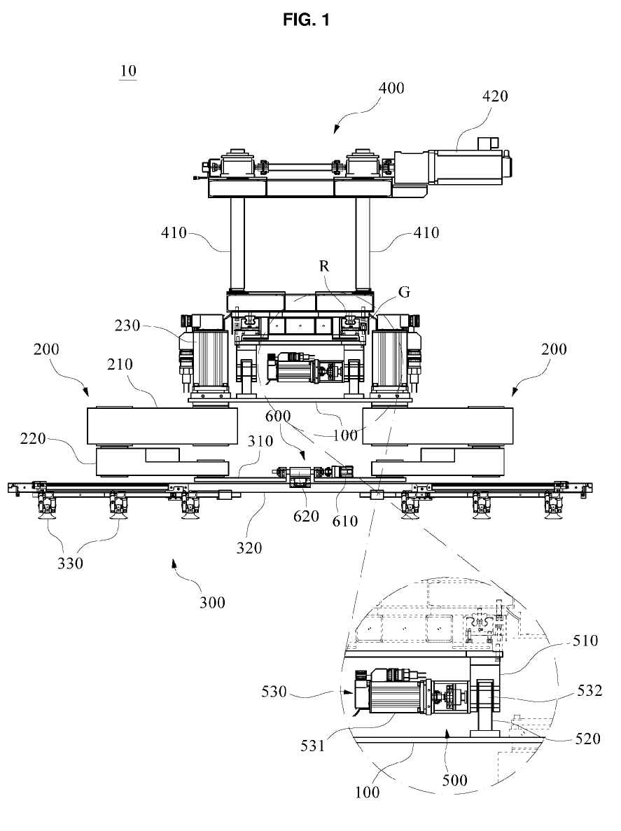

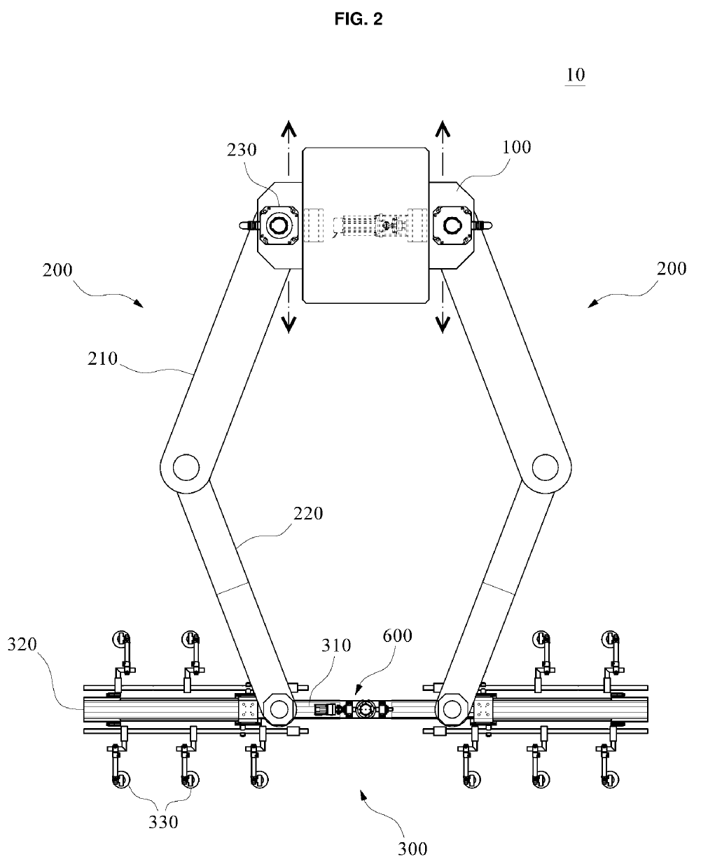

FIG. 1 is a front view of a transfer robot 10 according to an exemplary embodiment, and FIG. 2 is a plan view of the transfer robot 10. FIGS. 1 and 2 are illustrated under the condition that a workpiece is transferred along front and back directions of the transfer robot 10.

The transfer robot 10 includes a main plate 100, a pair of arm units 200, a workpiece coupling support 300 and an elevating unit 400.

The main plate 100 serves to connect parts of the transfer robot 10 and its lengthwise direction is disposed perpendicularly to a transferring direction of a workpiece.

The pair of arm units 200 are hinge-coupled to both lengthwise ends of the main plate 100. Each arm unit 200 includes a first arm 210 hinge-coupled to the main plate 100 and a second arm 220 coupled to an end of the first arm 210. The first arm 210 is rotated by a first motor 230 placed on a hinge-coupling shaft of the first arm 210 and the main plate 100, and the second arm 220 is rotated as the first arm 210 is rotated. To control the second arm 220, which is not directly connected to the first motor 230, a shaft of the first motor 230 and a rotary shaft of the second arm 220 may be connected by a timing belt or the like.

The workpiece coupling support 300 has opposite ends coupled to the ends of each arm unit 200, in more detail to the ends of the second arms 220, and is thus shaped connecting the ends of the second arm 220. The workpiece coupling support 300 couples with a workpiece desired to be transferred and is separated from the workpiece if the workpiece is completely transferred from one press to the other press.

Under the workpiece coupling support 300, a plurality of suction plates 330 is formed so that a workpiece can be firmly held on the workpiece coupling support 300 while the workpiece is transferred.

The main plate 100 moves up and down by the elevating unit 400. At this time, the arm unit 200 and the like move up and down together with the main plate 100. The elevating unit 400 moves the main plate 100 up while the workpiece is transferred, thereby preventing the workpiece from contact with the press 20. Further, the elevating unit 400 moves the main plate 100 down while the workpiece is put on another press 20, thereby stably putting the workpiece on the press.

As shown in FIG. 1, the elevating unit 400 includes a vertical bar 410 coupling with the main plate 100, and a second motor 420 moving the vertical bar 410 up and down. To transform a rotary motion of the second motor 420 into a vertical motion of the vertical bar 410, the rotary shaft of the second motor 420 may be formed with a pinion, and the vertical bar 410 may be formed with a rack.

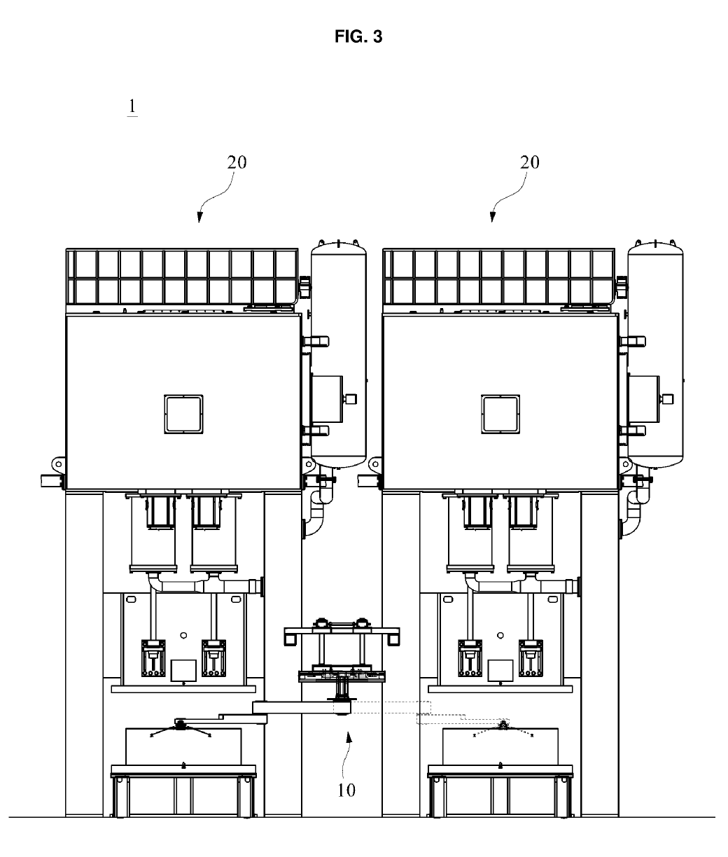

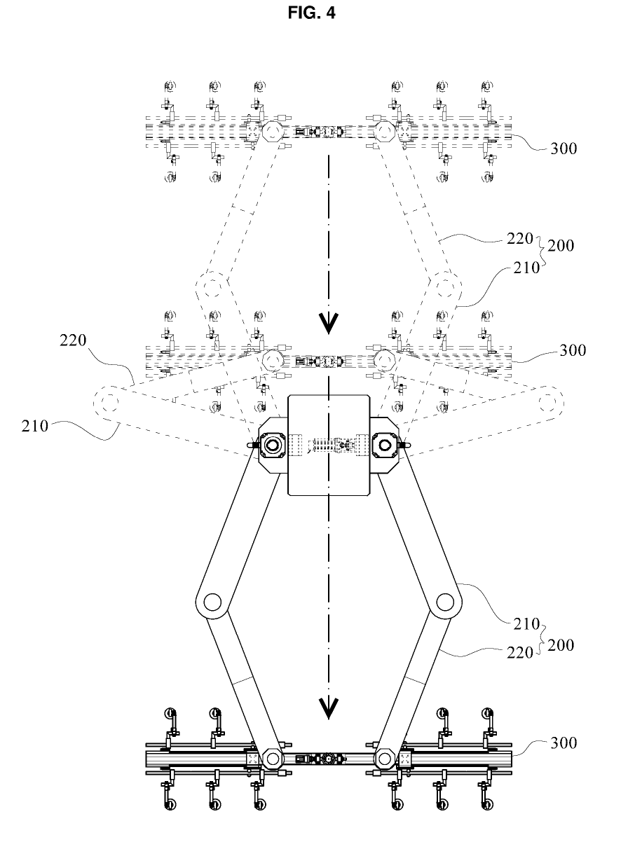

FIG. 3 illustrates that the transfer robot 10 is installed in a press line 1, and FIG. 4 illustrates an operation of the transfer robot 10. It will be appreciated that the press line 1 may include more presses 20 than those shown in FIG. 3.

The transfer robot 10 can rapidly transfer a workpiece since the workpiece is linearly moved while an angle between the first and second arms 210 and 220 of the arm unit 200 is varied as shown in FIG. 4, and prevent a large-scale press line since the transfer robot 10 occupies a small space in the state that the first and second arms 210 and 220 are completely folded.

In the transfer robot 10 according to an exemplary embodiment, the main plate 100 slides in the transferring direction of a workpiece with respect to the elevating unit 400.

When the transfer robot 10 operates, in particular, when the transfer robot 10 coupling with a workpiece is stopped from moving, a shock is given to a coupling portion between the arm unit 200 and the main plate 100 due to acceleration. By the way, the main plate 100 can slide and therefore relieve the shock by sliding when the speed of the transfer robot 10 is largely changed, thereby preventing the shock from being repetitively applied to only one spot. Accordingly, it is possible to decrease a possibility that the coupling potion between the arm unit 200 and the main plate 100 is damaged by an intensive load.

As shown in FIG. 1, one of the main plate 100 and the elevating unit 400 is formed with a rail R in the transferring direction of the workpiece, and the other one is formed with a rail groove G to thereby form a sliding path.

At opposite ends of the sliding path, a coil spring or the like elastic member may be provided to have a larger effect on relieving a shock.

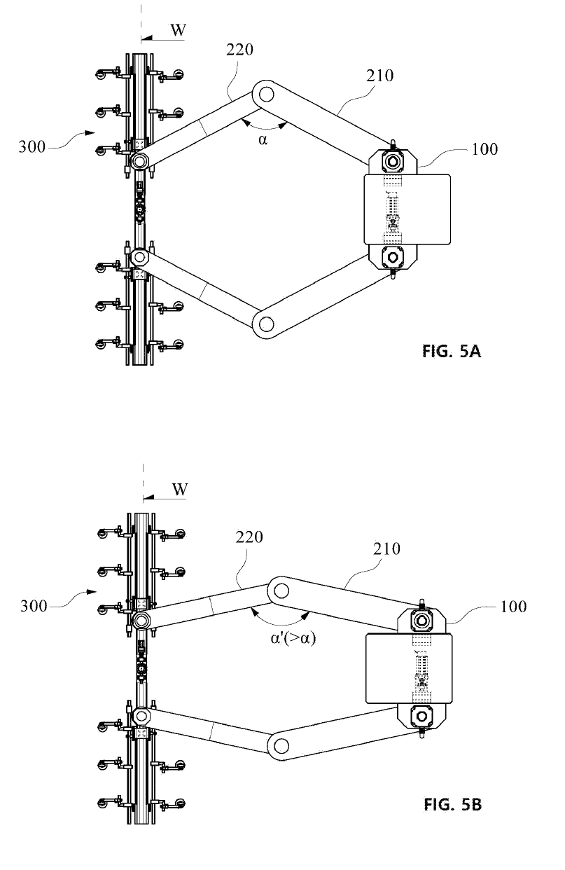

According to an exemplary embodiment, the transfer robot 10 may further include a position control unit (not shown) that adjusts an angle of the arm unit 200 in accordance with a sliding position of the main plate 100 and makes the end of the arm unit 200 be stopped at a certain position. FIGS. 5A and 5B are views for explaining position controls by a position control unit of the transfer robot.

Since the main plate 100 is provided to slide, the workpiece coupling support 300 is positioned at different places case by case, and therefore precision in transferring a workpiece is lowered. To prevent the precision from being lowered, the position control unit is provided. In other words, if the main plate 100 is stopped at a place relatively close to a position W of a workpiece as shown in FIG. 5A, the position control unit decreases an angle α between the first and second arms 210 and 220 of the arm unit 200. On the other hand, if the main plate 100 is stopped at a place relatively far away from the position W of the workpiece as shown in FIG. 5B, the position control unit increases an angle α′ between the first and second arms 210 and 220 of the arm unit 200. Therefore, the workpiece coupling support 300 can be always positioned at the same place.

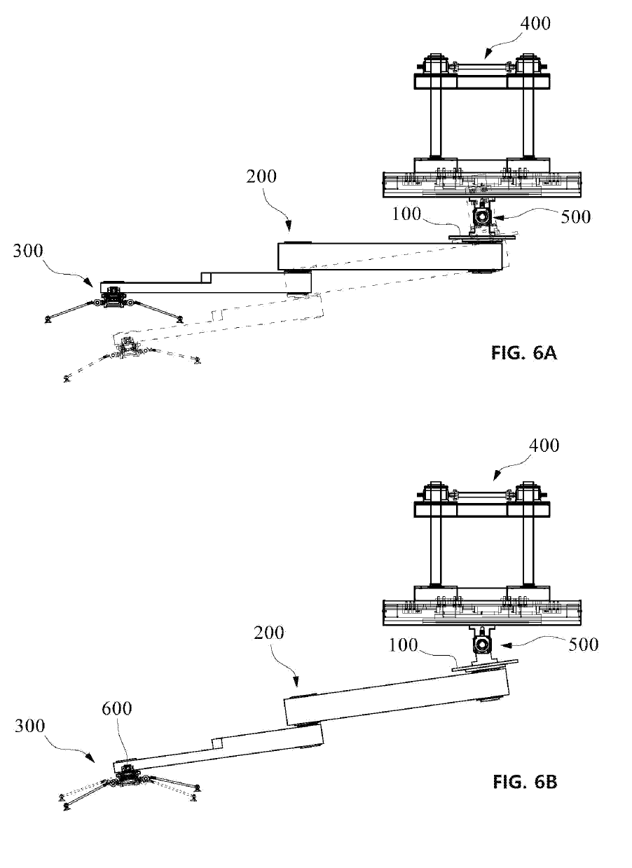

The transfer robot 10 may further include a first tilting unit 500 for tilting the main plate 100 in the transferring direction of a workpiece with respect to the elevating unit 400. FIG. 6A is a view for explaining the first tilting unit 500.

Since the main plate 100 is tilted by the first tilting unit 500, the workpiece coupling support 300 coupling with the main plate 100 through the arm unit 200 can move up and down. The first tilting unit 500 moves a workpiece up while transferring the workpiece, and moves the workpiece down while putting the workpiece on another press 20, thereby working like the elevating unit 400.

As shown in FIG. 1, the first tilting unit 500 includes a first pin hole portion 510 fastened to the elevating unit 400, a second pin hole portion 520 fastened to the main plate 100 and coupling with the first pin hole portion 510, and a third motor 530 having a motor main body 531 coupled to the first pin hole portion 510 and a motor shaft 532 coupled to the second pin hole portion 520. As the third motor 530 operates, the main plate 100 coupling with the motor shaft is tilted.

In the case where the transfer robot 10 additionally includes the first tilting unit 500, the elevating unit 400 does not always operate every time when the workpiece is transferred, but operates only when the height of the workpiece coupling support 300 has to be changed, for example, only when the size of the workpiece to be transferred is changed.

The workpiece coupling support 300 may include a connecting portion 310 coupling with the pair of arm units 200, and a workpiece coupler 320 connecting in parallel with the connecting portion 310 and tiltable by a second tilting unit 600 toward the transferring direction of the workpiece with respect to the connecting portion 310. FIG. 6B is a view for explaining the second tilting unit 600.

The workpiece coupler 320 tiltable by the second tilting unit 600 is tilted to dispose an irregular-shaped workpiece at a stable angle while the irregular-shaped workpiece is transferred, and thus prevents the load of the workpiece from being biased toward one side. Further, with the first tilting unit 500, the second tilting unit 600 keeps the workpiece at a stable angle even though the main plate 100 is leaning and thus the whole workpiece coupling support 300 is leaning.

The second tilting unit 600 may include a fourth motor that includes a motor main body 610 fastened to the connecting portion 310, and a motor shaft 620 fastened to the workpiece coupler 320.

Besides the foregoing elements, the transfer robot 10 according to an exemplary embodiment may further include a control unit for automatically adjusting the angle of the arm unit 200 and an angle change thereof, the height of the main plate 100 or the like due to the operation of the elevating unit 400, and the inclined angle of the arm unit 200 or the like due to the first and second tilting units 500 and 600, etc.

According to an exemplary embodiment, the transfer robot is excellent in durability since the main plate slides when a workpiece is transferred at a high acceleration, and it is thus possible to relieve a shock in a coupling portion between a movable arm unit and an immovable portion and prevent the shock from being repetitively applied to only one spot.

The position control unit prevents the precision in transferring a workpiece from being lowered even though the main plate slides.

The first tilting unit and the second tilting unit allow the transfer robot to easily and stably transfer a workpiece.

Although a few exemplary embodiments have been shown and described, it will be appreciated by those skilled in the art that changes may be made in these exemplary embodiments without departing from the principles and spirit of the invention. Accordingly, all suitable modification and equivalents may fall within the scope of the invention.

Reference numerals

```
    1: press line
  10: transfer robot
  20: press
100: main plate
200: arm unit
210: first arm
220: second arm
230: first motor
300: workpiece coupling support
310: connecting portion
320: workpiece coupler
400: elevating unit
500: first tilting unit
600: second tilting unit
```

What is claimed is:

1. An ultra-high speed transfer robot for transferring a workpiece from a first press to a second press in an ultra-high speed hybrid press line, the transfer robot comprising:
a main plate (100) which is formed horizontally and flat and of which a lengthwise direction is perpendicular to a transferring direction of the workpiece;
a pair of arm units (200) which are respectively hinge-coupled to both lengthwise ends of the main plate (100) and comprise a plurality of arms rotating against each other on a plane parallel with the main plate (100);
a workpiece coupling support (300) which comprise opposite ends respectively coupling with the ends of the pair of arm units (200); and
an elevating unit (400) which moves the main plate (100) up and down,
each arm unit (200) comprising a first arm (210) coupling with the main plate (100) and rotating by a first motor (230) and a second arm (220) coupling with an end of the first arm (210) and rotating as the first arm (210) rotates,
the main plate (100) sliding in the transferring direction of the workpiece with respect to the elevating unit (400), and
the transfer robot further comprising a position control unit to make the end of the arm unit (200) be stopped at a certain position by adjusting an angle of the arm unit (200) in accordance with a sliding position of the main plate (100).

2. The ultra-high speed transfer robot for the ultra-high speed hybrid press according to claim 1, further comprising a first tilting unit (500) configured to tilt the main plate (100) toward the transferring direction of the workpiece with respect to the elevating unit (400).

3. The ultra-high speed transfer robot for the ultra-high speed hybrid press according to claim 1, wherein the workpiece coupling support (300) comprises:
a connecting portion (310) coupling with the pair of arm units (200); and
a workpiece coupler (320) connecting in parallel with the connecting portion (310) and tiltable by a second tilting unit (600) toward the transferring direction of the workpiece with respect to the connecting portion (310).
